(19) United States
(12) Patent Application Publication
(10) Pub. No.: US 2008/0239190 A1
(43) Pub. Date: Oct. 2, 2008

(54) PIXEL STRUCTURE AND DRIVING METHOD

(75) Inventors: Ting-Chang Hsu, Taoyuan County (TW); Hsien-Chun Wang, Taoyuan County (TW); Tzu-Chien Huang, Taoyuan County (TW)

Correspondence Address: JIANQ CHYUN INTELLECTUAL PROPERTY OFFICE, 7 FLOOR-1, NO. 100, ROOSEVELT ROAD, SECTION 2, TAIPEI, 100, TW

(73) Assignee: CHUNGHWA PICTURE TUBES, LTD., Taipei (TW)

(21) Appl. No.: 11/828,362

(22) Filed: Jul. 26, 2007

(30) Foreign Application Priority Data
Mar. 30, 2007 (TW) 96111243

(51) Int. Cl. G02F 1/133; G02F 1/136

(52) U.S. Cl. 349/48; 349/33

(57) ABSTRACT

A pixel structure includes a scan line, a data line, a first thin film transistor (TFT), a second TFT, a first pixel electrode, a second pixel electrode and a third pixel electrode. The first TFT and the second TFT respectively possessing a first drain electrode and a second drain electrode are electrically connected to the scan line and the data line. The first pixel electrode is electrically connected to the first drain electrode. The second pixel electrode is placed on and coupled to parts of the first drain electrode, and the third pixel electrode is placed on and coupled to parts of the second drain electrode. As a result, the pixel structure is capable of reducing display quality variations arisen from different viewing angles.

### CROSS-REFERENCE TO RELATED APPLICATION

This application claims the priority benefit of Taiwan application serial no. 96111243, filed Mar. 30, 2007. All disclosure of the Taiwan application is incorporated herein by reference.

### BACKGROUND OF THE INVENTION

1. Field of the Invention

The present invention generally relates to a pixel structure of a liquid crystal display (LCD) panel, and more particularly, to a pixel structure of a multi-domain vertical alignment (MVA) LCD panel.

2. Description of Related Art

Currently, the LCDs have been mostly developed towards high luminance, high contrast ratio, large display size and wide viewing angle. In order to increase the view angle of the LCDs, several wide-viewing-angle techniques have been proposed. The most popular LCDs with the wide-viewing-angle feature include, for example, an MVA LCD, an in-plane switching (IPS) LCD, and a fringe field switching (FFS) LCD.

FIG. 1 is a top view of a pixel structure applied to a MVA display according to the conventional art. Referring to FIG. 1, a pixel structure 100 is disposed on a thin film transistor (TFT) array substrate and includes a scan line 110, a data line 120, a TFT 130, a pixel electrode 140 and an alignment member 150. The TFT 130 includes a gate electrode 132, a semiconductor layer 134, a source electrode 136a, a drain electrode 136b and a contact hole 138. The gate electrode 132 and the scan line 110 are electrically connected to each other, and the semiconductor layer 134 is disposed over the gate electrode 132. The source electrode 136a and the drain electrode 136b are disposed on the semiconductor layer 134, and the source electrode 136a is electrically connected to the data line 120.

The pixel electrode 140 is electrically connected to the drain electrode 136b via the contact hole 138. In addition, in order to enable liquid crystal molecules to generate an MVA, the alignment member 150 is disposed on the pixel electrode 140, and a plurality of alignment members (not shown) is disposed on a corresponding color filter substrate (not shown). Therefore, with the alignment member 150 and the plurality of the alignment members (not shown), the liquid crystal molecules disposed between the TFT array substrate and the color filter substrate may have various tilt directions, and the wide-viewing-angle effect can then be achieved.

Said MVA LCD is able to increase a range of the viewing angle. However, the light transmission rate of the MVA LCD may vary corresponding to a gray-level gamma curve when the viewing angle is increased from 0 degree to 90 degrees. In brief, image color and image luminance both provided by the MVA LCD may be distorted to a greater extent due to different viewing angles.

### SUMMARY OF THE INVENTION

In view of the foregoing, the present invention is directed to provide a pixel structure for reducing display quality variations arisen from different viewing angles.

The present invention provides a pixel structure including a substrate, a scan line, a data line, a first TFT, a first pixel electrode, a second pixel electrode, a second TFT and a third pixel electrode. Here, the scan line, the data line, the first TFT, the first pixel electrode, the second pixel electrode, the second TFT and the third pixel electrode are all disposed on the substrate. The first TFT is electrically connected to the scan line and the data line and has a first drain electrode. The first pixel electrode is electrically connected to the first drain electrode. The second pixel electrode is disposed over and is coupled to the first drain electrode. The second TFT is electrically connected to the scan line and the data line and has a second drain electrode. The third pixel electrode is disposed over and is coupled to the second drain electrode.

According to an embodiment of the present invention, the pixel structure further comprises a first common line, a second common line and a plurality of alignment members. The first common line is disposed on the substrate, wherein the first pixel electrode and the second pixel electrode overlap parts of the first common line, respectively. The second common line is disposed on the substrate, wherein the third pixel electrode overlaps parts of the second common line. The alignment members are disposed on the first pixel electrode, the second pixel electrode and the third pixel electrode.

According to an embodiment of the present invention, the alignment members include protrusions or slits.

According to an embodiment of the present invention, the pixel structure further includes a fourth pixel electrode disposed on the substrate and electrically connected to the second drain electrode. The fourth pixel electrode overlaps parts of the second common line, and the alignment members are further disposed on the fourth pixel electrode.

According to an embodiment of the present invention, the first pixel electrode is disposed between the second pixel electrode and the scan line.

According to an embodiment of the present invention, the fourth pixel electrode is disposed between the third pixel electrode and the scan line.

According to an embodiment of the present invention, the first TFT and the second TFT share a common source electrode.

According to an embodiment of the present invention, the first pixel electrode and the second pixel electrode are positioned at one side of the scan line, and the third pixel electrode is positioned at another.

According to an embodiment of the present invention, the first pixel electrode and the second pixel electrode are positioned at one side of the scan line, and the third pixel electrode and the fourth pixel electrode are positioned at another.

The present invention further provides a driving method of a pixel structure. The driving method is adapted to drive the aforesaid pixel structure and includes the following steps. First, the first TFT and the second TFT are turned on through the scan line. Thereafter, a data voltage is inputted to the first pixel electrode through the data line. Here, the second pixel electrode generates an induced voltage through the first drain electrode, and the third pixel electrode generates another induced voltage through the second drain electrode.

According to an embodiment of the present invention, the first common line and the second common line have different voltages.

According to an embodiment of the present invention, the first common line and the second common line have anti-phase voltages.

The present invention farther provides a driving method of a pixel structure. The driving method is adapted to drive the aforesaid pixel structure and includes the following steps. First, the first TFT and the second TFT are turned on through the scan line. Thereafter, a data voltage is inputted to the first pixel electrode and the fourth pixel electrode through the data line. Here, the second pixel electrode generates an induced voltage through the first drain electrode, the third pixel electrode generates another induced voltage through the second drain electrode, and the first common line and the second common line have different voltages.

According to an embodiment of the present invention, the first common line and the second common line have anti-phase voltages.

Based on the above, since the pixel structure of the present invention enables each of the pixel electrodes to reach different voltage levels according to said driving method, liquid crystal molecules disposed over each of the pixel electrodes then have different tilt angles, reducing the light transmission rate of an MVA LCD corresponding to a gray-level gamma curve to a certain degree based on variations in the viewing angles.

In order to the make the aforementioned and other objects, features and advantages of the present invention comprehensible, several embodiments accompanied with figures are described in detail below.

### BRIEF DESCRIPTION OF THE DRAWINGS

FIG. 1 is a top schematic view of a pixel structure applied to an MVA LCD according to the conventional art.

FIG. 2 is a top view of a pixel structure according to a first embodiment.

FIG. 3 is an equivalent circuit diagram of the pixel structure illustrated in FIG. 2.

FIG. 4 is a driving waveform of each of the pixel electrodes in the pixel structure illustrated in FIG. 2 after a driving method described in the first embodiment is performed.

FIG. 5 is a top view of a pixel structure according to a second embodiment.

FIG. 6 is an equivalent circuit diagram of the pixel structure illustrated in FIG. 5.

FIG. 7 is a driving waveform of each of the pixel electrodes in the pixel structure illustrated in FIG. 5 after the driving method described in the second embodiment is performed.

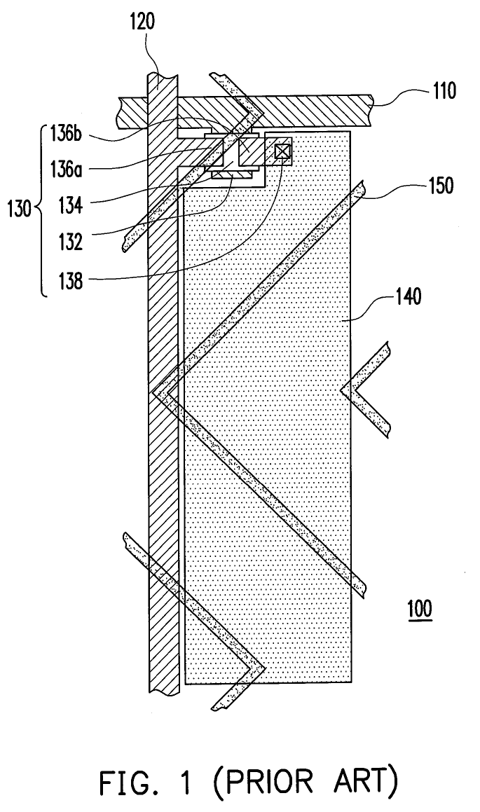

### DESCRIPTION OF EMBODIMENTS

### First Embodiment

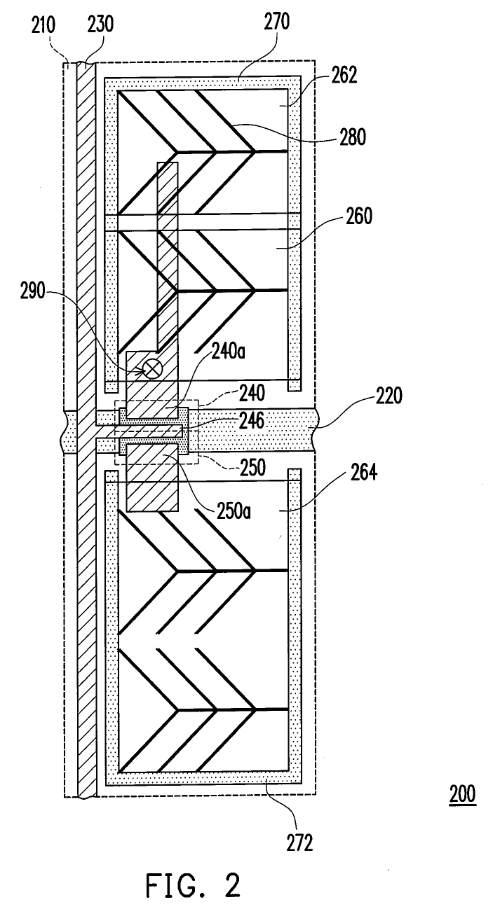

FIG. 2 is a top view of a pixel structure 200 according to a first embodiment. Referring to FIG. 2, the pixel structure 200 includes a substrate 210, a scan line 220, a data line 230, a first TFT 240, a first pixel electrode 260, a second pixel electrode 262, a second TFT 250 and a third pixel electrode 264. Here, the scan line 220, the data line 230, the first TFT 240, the first pixel electrode 260, the second pixel electrode 262, the second TFT 250 and the third pixel electrode 264 are all disposed on the substrate 210.

Particularly, the first TFT 240 is electrically connected to the scan line 220 and the data line 230 and has a first drain electrode 240a electrically connected to the first pixel electrode 260. In more details, the first drain electrode 240a is electrically connected to the first pixel electrode 260 via a first contact hole 290. The second pixel electrode 262 is floatingly disposed over parts of the first drain electrode 240a and is coupled to an extending portion of the first drain electrode 240a. More specifically, the first drain electrode 240a extends towards the second pixel electrode 262 in a direction parallel to the data line 230. After the first drain electrode 240a extends below the second pixel electrode 262, the extending portion is then coupled to the second pixel electrode 262 floatingly disposed over the extending portion. The second TFT 250 is electrically connected to the scan line 220 and the data line 250 and has a second drain electrode 250a. The third pixel electrode 264 is floatingly disposed over and is coupled to the second drain electrode 250a. On the other hand, in the present embodiment, the pixel structure 200 further includes a first common line 270 and a second common line 272. Here, the first pixel electrode 260 and the second pixel electrode 262 overlap parts of the first common line 270, respectively, while the third pixel electrode 264 overlaps parts of the second common line 272. However, the first common line 270 and the second common line 272 are not limited in the present invention. Moreover, as the pixel structure 200 has an MVA design, the pixel structure 200 further includes a plurality of alignment members 280. As shown in FIG. 2, the alignment members 280 are disposed on the first pixel electrode 260, the second pixel electrode 262 and the third pixel electrode 264. Nevertheless, as the pixel structure 200 has a twisted nematic (TN) design, the plurality of the alignment members 280 may not be included in the pixel structure 200. The plurality of the alignment members 280 is not limited in the present invention. In the present embodiment, the alignment members 280 are protrusions, while the alignment members 280 may be slits in another embodiment.

In the pixel structure 200, the first TFT 240 and the second TFT 250 share a common source electrode 246. However, in other embodiments, the first TFT 240 and the second TFT 250 may respectively have an individual source electrode. In other words, the modes and the types of the TFTs are not limited to those disclosed in FIG. 2 of the present invention. For example, in the present embodiment, the TFTs have straight channels and are directly disposed on the scan line. However, the TFTs may have U-shaped channels and may be disposed on the protrusions extended from the scan line.

Besides, the first pixel electrode 260 is disposed between the second pixel electrode 262 and the scan line 220. The first pixel electrode 260 and the second pixel electrode 262 are positioned at one side of the scan line 220, while the third pixel electrode 264 is positioned at another. Nevertheless, the disposition of said three pixel electrodes is merely exemplified but not limited in the present invention.

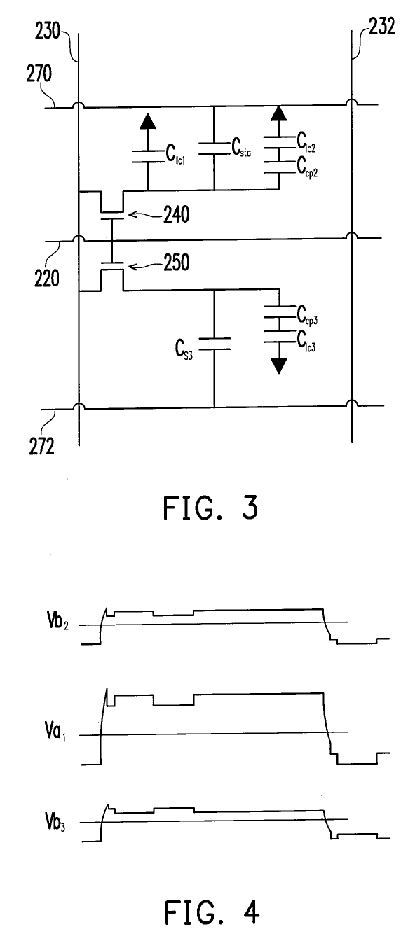

FIG. 3 is an equivalent circuit diagram of the pixel structure 200. The pixel structure 200 includes the scan line 220, the first common line 270, the second common line 272, a data line 230 and another data line 232 adjacent to the pixel structure 200, a first TFT 240 and a second TFT 250. Referring to FIGS. 2 and 3 together, C_{lc1} represents a first liquid crystal capacitance generated by the first pixel electrode 260 and a common electrode (not shown) on an opposite substrate. Cₛₜₐ denotes a total storage capacitance including the storage capacitance produced by the first pixel electrode 260 and the common line 270 and the storage capacitance produced by the second pixel electrode 262 and the common line 270. C_{lc2} refers to a second liquid crystal capacitance generated by the second pixel electrode 262 and the common electrode (not shown) on the opposite substrate. Moreover, the second pixel electrode 262 of the pixel structure 200 is floatingly disposed over parts of the first drain electrode 240a, and thus the second pixel electrode 262 and the underlying extending portion of the first drain electrode 240a are coupled to the first drain electrode 240a. Thereby, a second coupled capacitance C_{cp2} is generated between the second pixel electrode 262 and the first drain electrode 240a.

Referring to FIG. 3 again, C_{lc3} represents a third liquid crystal capacitance generated by the third pixel electrode 264 and the common electrode (not shown) on the opposite substrate, and Cₛ₃ denotes the storage capacitance generated by the third pixel electrode 264 and the common line 272. Furthermore, the third pixel electrode 264 of the pixel structure 200 is coupled to the second drain electrode 250a, and thus a third coupled capacitance C_{cp3} is generated between the third pixel electrode 264 and the second drain electrode 250a.

A driving method of the pixel structure 200 will be described hereinafter. Referring to FIGS. 2 and 3 together, the driving method of the pixel structure 200 includes the following steps. First, the first TFT 240 and the second TFT 250 are turned on through the scan line 220. Thereafter, a data voltage Va is inputted to the first pixel electrode 260 through the data line 230. Here, the second pixel electrode 262 generates an induced voltage Vb₂ through the first drain electrode 240a, and the third pixel electrode 264 generates another induced voltage Vb₃ through the second drain electrode 250a.

To be more specific, the coupled capacitances C_{cp2} and C_{cp3} and signals of the first common line 270 and the second common line 272 are adopted in the present invention, such that the three pixel electrodes reach different voltage levels. FIG. 4 is a driving waveform of each of the pixel electrodes in the pixel structure 200 after the driving method described above is performed. The first pixel electrode 260 has a driving waveform Va₁, the second pixel electrode 262 has a driving waveform Vb₂, and the third pixel electrode 264 has a driving waveform Vb₃. According to the present embodiment, the first common line 270 and the second common line 272 have anti-phase voltages, but the inputted voltages of the first common line 270 and the second common line 272 are not limited in the present embodiment. In other embodiments, the voltages inputted by the first common line 270 and the second common line 272 may also have a difference. The dissimilarities of the signal waveforms Va₁, Vb₂, and Vb₃ are clearly indicated in FIG. 4. That is to say, the pixel structure 200 of the present invention enables the three pixel electrodes in the pixel structure 200 to reach different voltage levels after said driving method is carried out, such that liquid crystal molecules disposed over the three pixel electrodes have different tilt angles, reducing the light transmission rate of an MVA LCD corresponding to a gray-level gamma curve to a certain degree according to variations in the viewing angles.

### Second Embodiment

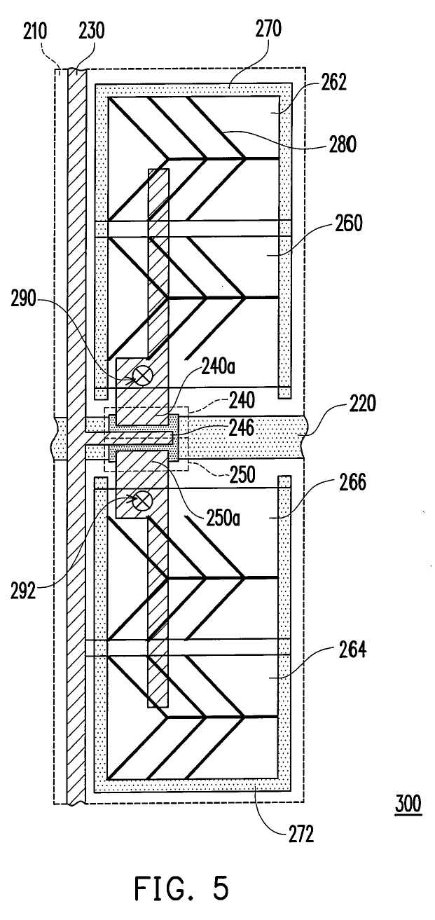

FIG. 5 is a top view of a pixel structure 300 according to another embodiment of the present invention. With reference to FIG. 5, the pixel structure 300 in the present embodiment and the pixel structure 200 in the first embodiment are similar, and the difference therebetween mainly lies in that a fourth pixel electrode 266 is further disposed between the third pixel electrode 264 and the scan line 220 in the pixel structure 300 of the present embodiment. In the present embodiment, the fourth pixel electrode 266 is electrically connected to the second drain electrode 250a and overlaps parts of the second common line 272. In details, the first drain electrode 240a is electrically connected to the first pixel electrode 260 via a first contact hole 290, while the second drain electrode 250a is electrically connected to the fourth pixel electrode 266 via a second contact hole 292. More specifically, in the pixel structure 300 of the present embodiment, the first pixel electrode 260 and the second pixel electrode 262 are positioned at one side of the scan line 220, while the third pixel electrode 264 and the fourth pixel electrode 266 are positioned at another.

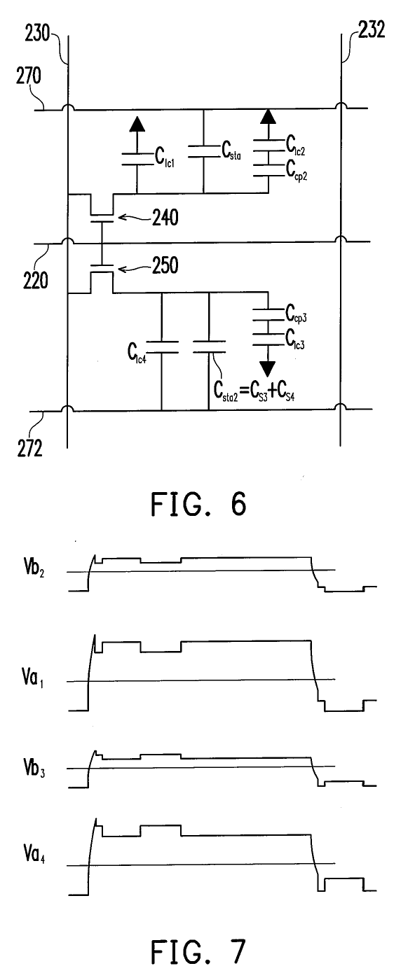

FIG. 6 is an equivalent circuit diagram of the pixel structure 300. Referring to FIGS. 6 and 7 together, the equivalent circuit diagram of the pixel structure 300 in the present embodiment and that of the pixel structure 200 in the first embodiment are similar, and the difference therebetween mainly lies in that the present embodiment further includes a fourth liquid crystal capacitance C_{lc4} generated by the fourth pixel electrode 266 and the common electrode (not shown) on the opposite substrate and a storage capacitance Cₛ₄ generated by the fourth pixel electrode 266 and the common line 272. In FIG. 6, Cₛₜₐ₂ represents the total storage capacitance of the third storage capacitance Cₛ₃ and the fourth storage capacitance Cₛ₄.

A driving method of the pixel structure 300 will be described hereinafter. Referring to FIGS. 5 and 6 together, the driving method of the pixel structure 300 includes the following steps. First, the first TFT 240 and the second TFT 250 are turned on through the scan line 220. Thereafter, a data voltage Va is inputted to the first pixel electrode 260 and the fourth pixel electrode 266 through the data line 230. Here, the second pixel electrode 262 generates the induced voltage Vb₂ through the first drain electrode 240a, and the third pixel electrode generates the induced voltage Vb₃ through the second drain electrode 250a.

More particularly, the coupled capacitances C_{cp2} and C_{cp3} and the signals of the first common line 270 and the second common line 272 are adopted in the present invention, such that the four pixel electrodes reach different voltage levels. FIG. 7 is a driving waveform of each of the pixel electrodes in the pixel structure 300 after the driving method described above is performed. The first pixel electrode 260 has the driving waveform Va₁, the second pixel electrode 262 has the driving waveform Vb₂, the third pixel electrode 264 has the driving waveform Vb₃, and the fourth pixel electrode 266 has a driving waveform Va₄. According to the present embodiment, the first common line 270 and the second common line 272 have anti-phase voltages, but the inputted voltages of the first common line 270 and the second common line 272 are not limited in the present embodiment. In other embodiments, the voltages inputted by the first common line 270 and the second common line 272 may also have a difference. The dissimilarities of the signal waveforms Va₁, Vb₂, Vb₃ and Va₄ are clearly indicated in FIG. 7.

Based on the above, the pixel structures 200 and 300 according to said two embodiments of the present invention enable each of the pixel electrodes in the pixel structure 200 or in the pixel structure 300 to reach different voltage levels after the afore-mentioned driving methods are performed, such that the liquid crystal molecules disposed over each of the pixel electrodes have the different tilt angles, reducing the light transmission rate of the MVA LCD corresponding to the gray-level gammua curve to a certain degree according to the variations in the viewing angles.

Although the present invention has been disclosed above by the embodiments, they are not intended to limit the present invention. Anybody skilled in the art can make some modifications and alteration without departing from the spirit and scope of the present invention. Therefore, the protecting range of the present invention falls in the appended claims.

What is claimed is:

1. A pixel structure, comprising:
a substrate;
a scan line disposed on the substrate;
a data line disposed on the substrate;
a first thin film transistor (TFT) disposed on the substrate and electrically connected to the scan line and the data line, wherein the first TFT has a first drain electrode;
a first pixel electrode disposed on the substrate and electrically connected to the first drain electrode;
a second pixel electrode disposed on the substrate, wherein the second pixel electrode is disposed over and is coupled to the first drain electrode;
a second TFT disposed on the substrate and electrically connected to the scan line and the data line, wherein the second TFT has a second drain electrode; and
a third pixel electrode disposed on the substrate, wherein the third pixel electrode is disposed over and is coupled to the second drain electrode.

2. The pixel structure as claimed in claim 1, further comprising:
a first common line disposed on the substrate, wherein the first pixel electrode and the second pixel electrode overlap parts of the first common line, respectively;
a second common line disposed on the substrate, wherein the third pixel electrode overlaps parts of the second common line; and
a plurality of alignment members disposed on the first pixel electrode, the second pixel electrode and the third pixel electrode.

3. The pixel structure as claimed in claim 2, wherein the alignment members comprise protrusions or slits.

4. The pixel structure as claimed in claim 2, further comprising a fourth pixel electrode disposed on the substrate and electrically connected to the second drain electrode, wherein the fourth pixel electrode overlaps parts of the second common line, and the alignment members are further disposed on the fourth pixel electrode.

5. The pixel structure as claimed in claim 4, wherein the first pixel electrode and the second pixel electrode are positioned at one side of the scan line, and the third pixel electrode and the fourth pixel electrode are positioned at another.

6. The pixel structure as claimed in claim 4, wherein the fourth pixel electrode is disposed between the third pixel electrode and the scan line.

7. The pixel structure as claimed in claim 1, wherein the first TFT and the second TFT share a common source electrode.

8. The pixel structure as claimed in claim 1, wherein the first pixel electrode and the second pixel electrode are positioned at one side of the scan line, and the third pixel electrode is positioned at another.

9. The pixel structure as claimed in claim 1, wherein the first pixel electrode is disposed between the second pixel electrode and the scan line.

10. A driving method of a pixel structure, wherein the driving method is adapted to drive the pixel structure as claimed in claim 2, the driving method of the pixel structure comprising:
turning on the first TFT and the second TFT through the scan line; and
inputting a data voltage to the first pixel electrode through the data line, wherein the second pixel electrode generates an induced voltage through the first drain electrode, and the third pixel electrode generates another induced voltage through the second drain electrode.

11. The driving method of the pixel structure as claimed in claim 10, wherein the first common line and the second common line have different voltages.

12. The driving method of the pixel structure as claimed in claim 11, wherein the first common line and the second common line have anti-phase voltages.

13. A driving method of a pixel structure, wherein the driving method is adapted to drive the pixel structure as claimed in claim 4, the driving method of the pixel structure comprising:
turning on the first TFT and the second TFT through the scan line; and
inputting a data voltage to the first pixel electrode and the fourth pixel electrode through the data line, wherein the second pixel electrode generates an induced voltage through the first drain electrode, the third pixel electrode generates another induced voltage through the second drain electrode, and the first common line and the second common line have different voltages.

14. The driving method of the pixel structure as claimed in claim 13, wherein the first common line and the second common line have anti-phase voltages.
